(19) United States
(12) Patent Application Publication
(10) Pub. No.: US 2026/0249933 A1
(43) Pub. Date: Aug. 27, 2026

(54) Crawler Roller, Crawler-Type Traveling Device, And Crawler-Type Machine

(71) Applicant: Caterpillar SARL, Geneva (CH)

(72) Inventor: Takayuki Naito, Akashi-shi, Hyogo (JP)

(21) Appl. No.: 19/160,799

(22) PCT Filed: Mar. 8, 2024
(86) PCT No.: PCT/EP2024/025109

§ 371 Date: Aug. 28, 2025

(30) Foreign Application Priority Data
Mar. 13, 2023 (JP) 2023-038513

(51) Int. Cl. B62D 55/14

(52) U.S. Cl. CPC B62D 55/14

(57) ABSTRACT

There are provided a crawler roller capable of suppressing a temperature rise due to friction with a crawler belt, a crawler-type traveling device including the same, and a crawler-type machine including the same. A crawler roller includes: a roller body portion having a cylindrical shape; a pair of flange portions for preventing a crawler belt from falling off, the flange portions protruding from the roller body portion in a radial direction; and groove portions for heat dissipation in which at least a part of a bottom portion does not have a welding portion, the groove portions being formed on at least any of the flange portions, and an outer peripheral surface of the roller body portion excluding the flange portions.

### TECHNICAL FIELD

The present invention relates to a crawler roller that supports and guides a crawler belt, a crawler-type traveling device including the same, and a crawler-type machine including the same.

### BACKGROUND ART

A work machine such as a crawler-type tractor or an excavator is usually supported and moved by one set of lower traveling body assemblies. Each lower traveling body assembly includes an endless drive crawler chain having a plurality of interconnected articulated components or links. In addition, the lower traveling body assembly generally includes a drive sprocket, one or more driven wheels, a plurality of track rollers, and carrier rollers, and drives the drive crawler chain around these components to move forward and backward (for example, refer to PTL 1 to 3).

### CITATION LIST

### Patent Literature

PTL 1: JP-A-2001-187589

PTL 2: JP-A- 2001-354172

PTL 3: JP-A-2021-98513

### SUMMARY OF THE INVENTION

### Technical Problem

The track rollers and the carrier rollers rotate while coming into contact with the drive crawler chain during traveling. These rollers are often injected with grease for lubrication or enclosed with lubricating oil in order to rotate smoothly. However, when the traveling is continued at a high speed for a long time, the roller may generate heat due to friction with the drive crawler chain and may become a high temperature. The high temperature deteriorates performance of a Seal component that encloses a lubricant, which leads to defects such as oil leakage and grease leakage. When such oil leakage and grease leakage occur, the soil is contaminated with grease or oil. Furthermore, when the roller is in a high-temperature state for a long period of time, there is a concern that the lubricant may deteriorate, or the lubrication may be insufficient and a bearing portion may be seized. When the roller cannot smoothly rotate, large friction is generated between the roller and the drive crawler chain, and there is a concern that the roller or the drive crawler chain may be damaged due to wear.

The present invention has been made in view of such a point, and an object of the present invention is to provide a crawler roller capable of suppressing a temperature rise due to friction with a crawler belt, a crawler-type traveling device including the same, and a crawler-type machine including the same.

### Solution to Problem

According to the invention of claim 1, there is provided a crawler roller that supports and guides a crawler belt, including: a roller body portion having a cylindrical shape; a pair of flange portions for preventing the crawler belt from falling off, the flange portions protruding from the roller body portion in a radial direction; and groove portions for heat dissipation in which at least a part of a bottom portion does not have a welding portion, the groove portions formed on at least any of the flange portions, and an outer peripheral surface of the roller body portion excluding the flange portions.

According to the invention of Claim 2, in the crawler roller according to Claim 1, the groove portions are formed on the outer peripheral surface of the roller body portion in a direction intersecting with an axial direction of the roller body portion.

According to the invention of Claim 3, in the crawler roller according to Claim 1, the groove portions are formed on the outer peripheral surface of the roller body portion along an axial direction of the roller body portion.

According to the invention of Claim 4, in the crawler roller according to Claim 1, the groove portions are formed on the outer peripheral surface of the roller body portion in a spiral shape with respect to an axial direction of the roller body portion.

According to the invention of Claim 5, in the crawler roller according to Claim 1, the groove portions formed on the flange portions are formed concentrically.

According to the invention of Claim 6, in the crawler roller according to Claim 1, the groove portions formed on the flange portions are formed radially in a radial direction.

According to the invention of claim 7, there is provided a crawler-type traveling device including a crawler belt; and the crawler roller according to any one of Claims 1 to 6 that supports and guides the crawler belt.

According to the invention of Claim 8, there is provided a crawler-type machine including a crawler belt; and the crawler-type traveling device according to Claim 7 that supports and guides the crawler belt.

### Advantageous Effects of Invention

According to the invention of Claim 1, a surface area of the crawler roller is increased by the groove portion, and a heat dissipation property can be improved. Therefore, even if the crawler roller generates heat due to friction with the crawler belt during traveling, the heat is dissipated from the surface expanded by the groove portion, and the temperature rise can be suppressed.

According to the invention of Claim 2, a large number of the groove portions can be easily formed by effectively using the outer peripheral surface of the roller body portion.

According to the invention of Claim 3, a large number of the groove portions can be easily formed by effectively using the outer peripheral surface of the roller body portion.

According to the invention of Claim 4, a large number of the groove portions can be easily formed by effectively using the outer peripheral surface of the roller body portion.

According to the invention of Claim 5, a large number of the groove portions can be easily formed by effectively using the flange portions.

According to the invention of Claim 6, a large number of the groove portions can be easily formed by effectively using the flange portions.

According to the invention of Claim 7, since the crawler roller can be smoothly rotated, the friction between the crawler roller and the crawler belt can be suppressed, and the wear or damage of the crawler roller or the crawler belt can be suppressed.

According to the invention of Claim 8, it is possible to provide a crawler-type machine having high durability and reliability.

### BRIEF DESCRIPTION OF DRAWINGS

FIG. 1 shows an embodiment of a crawler roller according to the present invention, FIG. 1(a) is a cross-sectional view of a first example of a track roller as the crawler roller, and FIG. 1(b) is a side view thereof.

FIG. 2(a) is a cross-sectional view of a second example of a track roller as the crawler roller, and

FIG. 2(b) is a side view thereof.

FIG. 3(a) is a cross-sectional view of a third example of a track roller as the crawler roller, and

FIG. 3(b) is a side view thereof.

FIG. 4(a) is a cross-sectional view of a fourth example of a track roller as the crawler roller, and

FIG. 4(b) is a side view thereof.

FIG. 5(a) is a cross-sectional view showing an example of a carrier roller as the crawler roller, and

FIG. 5(b) is a side view thereof.

FIG. 6 is a side view of a crawler-type machine including a crawler-type traveling device having the crawler roller.

### DETAILED DESCRIPTION OF THE INVENTION

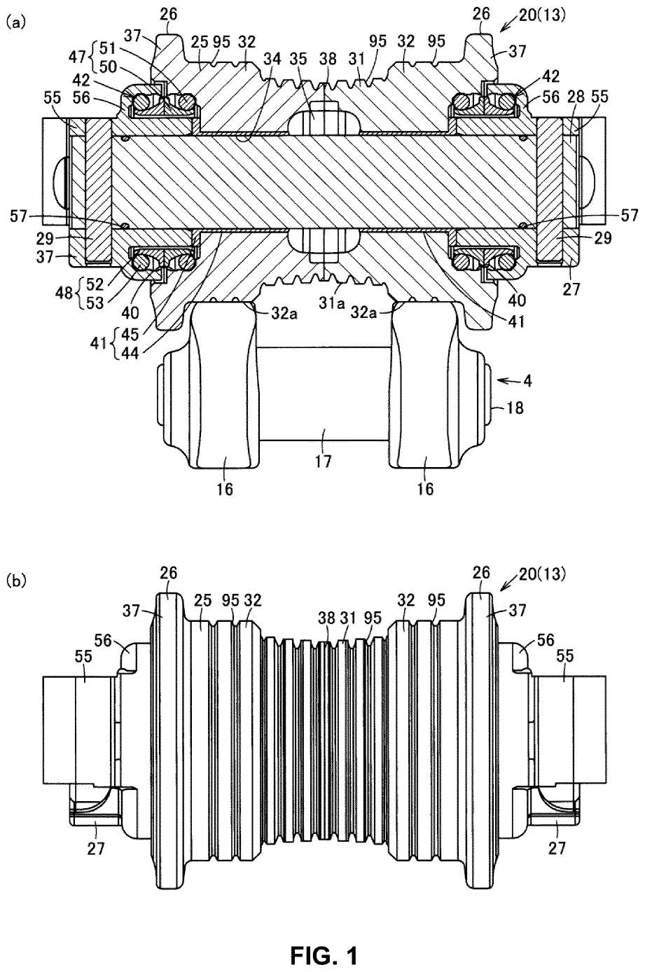

Hereinafter, the present invention will be described in detail based on an embodiment shown in FIGS. 1 to 6.

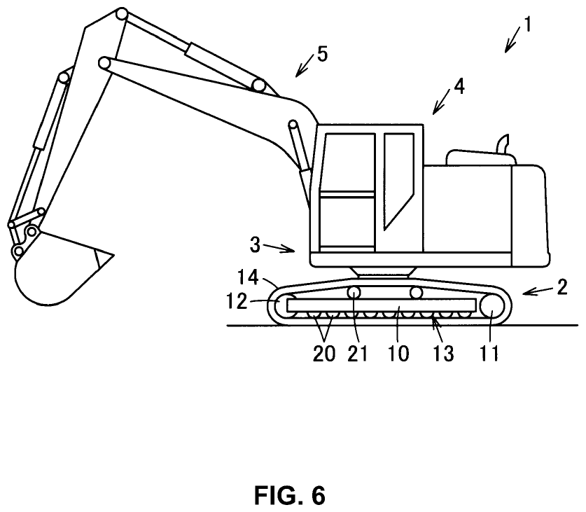

FIG. 6 shows a crawler-type machine 1. In the present embodiment, for example, a hydraulic excavator that performs work such as excavation is illustrated as an example of the crawler-type machine 1. The crawler-type machine 1 has a crawler-type traveling device 2 and a machine body 3 that is supported by the crawler-type traveling device 2 serving as a lower traveling body. The machine body 3 is equipped with a cab 4 that forms an operator cab in which an operator is seated, an engine, a tank for a working fluid, and the like. In the present embodiment, the machine body 3 is an upper swing body that is supported to be swingable with respect to the crawler-type traveling device 2, and a work device 5 is disposed in the machine body 3. The crawler-type machine 1 is not limited to a construction machine, and may be an agricultural work machine or the like.

A pair of the crawler-type traveling devices 2 are set on the left and right. Each of the crawler-type traveling devices 2 includes a frame 10, a sprocket 11, a driven wheel (idler) 12, a plurality of crawler rollers 13, and an endless crawler belt 14. The sprocket 11, the driven wheel 12, and the crawler roller 13 are rotatably provided on the frame 10 which is long in a front-rear direction, and the crawler belt 14 is wound around the sprocket 11, the driven wheel 12, and the crawler roller 13. The crawler belt 14 is also referred to as a drive crawler chain and is configured such that, as shown in FIG. 1(a), a plurality of left and right pairs of links 16 are connected to each other in an endless manner via pins 18 inserted into bushes 17 having a cylindrical shape, and a shoe (track shoe) is fixed to the links 16 to cover the links 16. As shown in FIG. 6, the crawler-type machine 1 is configured to move forward and backward by driving the crawler belt 14 by the sprocket 11 to rotate around the driven wheel 12 and the crawler rollers 13.

In the present embodiment, the driven wheel 12 forms a pair with the sprocket 11 and is set only in the front or rear, but may be set in a plurality depending on the type of the crawler-type machine 1.

A track roller 20 located at a lower portion of the frame 10 and a carrier roller 21 located at an upper portion of the frame 10 are set in the crawler roller 13.

The track roller 20 shown in FIGS. 1 to 4 as an example has a roller body portion 25 having a cylindrical shape and a pair of flange portions 26 formed on the roller body portion 25. Collars 27 having a cylindrical shape are disposed at both end portions of the roller body portion 25 in an axial direction, and a shaft 28 is disposed to penetrate the roller body portion 25 between the collars 27 and 27. The collar 27 and the shaft 28 are prevented from rotating and fixed to each other by a fixing pin 29. Then, at least any one of the collar 27 and the shaft 28 is fixed to the frame 10 (FIG. 6), so that the roller body portion 25 rotates about the shaft 28 together with the flange portion 26.

The roller body portion 25 may have a constant outer diameter dimension, or the outer diameter dimension may change within a range not exceeding an outer diameter dimension of the flange portion 26. In the present embodiment, the roller body portion 25 has a small-diameter portion 31 having a relatively small outer diameter dimension and a large-diameter portion 32 having a relatively large outer diameter dimension. In the shown example, the small-diameter portion 31 is formed on a central portion in the axial direction, and the large-diameter portions 32 are formed at both end portions of the small-diameter portion 31. Both end portions of the small-diameter portion 31 and the large-diameter portion 32 are connected in a stepped manner. An outer peripheral surface 32a of the large-diameter portion 32 is a contact portion with which the link 16 of the crawler belt 14 comes into contact at a lower portion, and an outer peripheral surface 31a of the small-diameter portion 31 is a facing portion that is separated from and faces the crawler belt 14.

In addition, an insertion hole 34 into which the shaft 28 is inserted is formed inside the roller body portion 25, and a lubricant holding portion 35 is formed to communicate with the insertion hole 34. The insertion hole 34 has a constant or substantially constant diameter dimension between both end portions of the roller body portion 25. The lubricant holding portion 35 is a portion that holds a lubricant in a fluid state such as lubricating oil, and is formed to be enlarged with respect to the insertion hole 34. In the present embodiment, the lubricant holding portion 35 is located at a central portion of the roller body portion 25 in a longitudinal direction and is located inside the small-diameter portion 31.

The roller body portion 25 may be formed of a plurality of members or may be integrally formed according to the size of the track roller 20. In the present embodiment, the roller body portion 25 is integrally formed by two rim members 37 having a cylindrical shape butting against each other in the axial direction and being welded to each other. Therefore, a welding portion 38 for welding the rim members 37 to each other is formed at the central portion of the roller body portion 25 in the axial direction. The welding portion 38 is located on end surfaces of the rim members 37 facing each other and continues over an entire circumference of the roller body portion 25.

The flange portion 26 restricts left and right positions of the crawler belt 14 such that the crawler belt 14 does not fall off from the track roller 20. The flange portions 26 may be a pair or two or more pairs depending on the size of the track roller 20. However, in the present embodiment, a pair of flange portions 26 set at both end portions of the roller body portion 25, that is, in the present embodiment, set at the large-diameter portions 32 are shown. The flange portion 26 protrudes in a radial direction from the outer peripheral surface of the roller body portion 25 over the entire circumference of the roller body portion 25.

Further, recessed portions 40 are formed at both end portions of the roller body portion 25. The recessed portions 40 are formed to communicate with the insertion hole 34. A bush 41 is disposed from the recessed portion 40 to the insertion hole 34, and a seal assembly 42 is disposed inside the recessed portion 40.

The bush 41 has a cylindrical shape into which the shaft 28 is inserted. The bush 41 has a bush body portion 44 having a cylindrical shape and a bush flange portion 45 protruding in a flange shape in a radial direction from the bush body portion 44. The bush body portion 44 is press-fitted into the insertion hole 34, and an outer peripheral surface of the bush body portion 44 is in close contact with an inner surface of the insertion hole 34 from the recessed portion 40 to the lubricant holding portion 35. The bush flange portion 45 is located in the recessed portion 40 and receives an end surface of the collar 27. An inner diameter dimension of the bush 41 is slightly larger than an outer diameter dimension of the shaft 28, and the bush 41 is rotatable with respect to the shaft 28 together with the track roller 20.

The seal assembly 42 prevents the lubricant from leaking from the lubricant holding portion 35 and prevents mud, dirt, and the like from entering the lubricant holding portion 35 from the outside into a rotary part. The seal assembly 42 is configured such that a roller-side seal portion 47 as a first seal portion located on the roller body portion 25 side and a collar-side seal portion 48 as a second seal portion located on the collar 27 side are adjacent to each other in the axial direction.

The roller-side seal portion 47 has an annular seal ring 50 and a seal member 51 that is held on an outer periphery of the seal ring 50 and is in pressure contact with an inner surface of the recessed portion 40 with respect to the roller body portion 25. Similarly, the collar-side seal portion 48 has an annular seal ring 52 and a seal member 53 that is held on an outer periphery of the seal ring 52 and is in pressure contact with the collar 27. The seal rings 50 and 52 are located adjacent to each other in the axial direction of the track roller 20.

The collar 27 is press-fitted to an end portion of the shaft 28 at a position where the lubricant is prevented from passing between the seal rings 50 and 52 and an inner side surface of the recessed portion 40 and between the seal members 51 and 53 and the inner side surface of the recessed portion 40. The collar 27 has a collar body portion 55 having a cylindrical shape and an extension portion 56 extending from an outer peripheral surface of the collar body portion 55. The collar body portion 55 is press-fitted into the shaft 28, one end portion thereof faces the bush flange portion 45 of the bush 41, and the other end portion thereof protrudes outward from the recessed portion 40. An annular seal 57 that is in pressure contact with an outer peripheral surface of the shaft 28 is disposed on an inner surface of the collar body portion 55. In addition, an axial gap is formed between one end portion of the collar body portion 55 and the bush flange portion 45 of the bush 41 in order to supply the lubricant from the lubricant holding portion 35 to the seal assembly 42. The extension portion 56 extends from the outer peripheral surface of the collar body portion 55 to an end portion side of the roller body portion 25 by being bent, and a distal end portion thereof is inserted into the recessed portion 40 and is in close contact with the recessed portion 40. The fixing pin 29 is inserted into a through hole formed from the bush body portion 44 to the shaft 28 so that the collar 27 and the shaft 28 are integrally fixed.

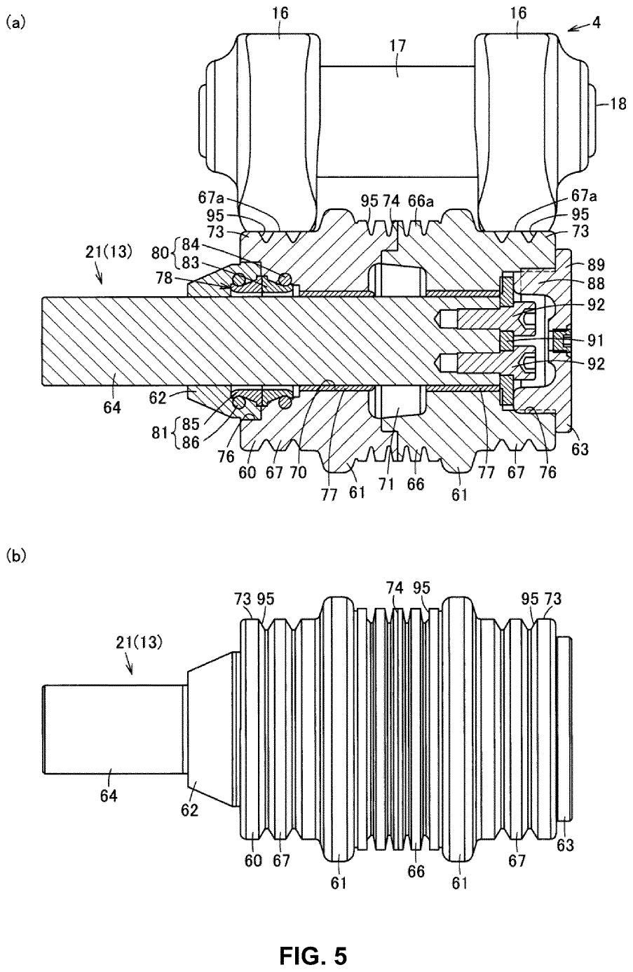

In addition, the carrier roller 21 shown in FIG. 5(a) and FIG. 5(b) as an example has a roller body portion 60 having a cylindrical shape and a pair of flange portions 61 formed on the roller body portion 60. A retainer 62 having a cylindrical shape is disposed at one end portion of the roller body portion 60 in the axial direction, a cover 63 is disposed at the other end portion of the roller body portion 60, and a shaft 64 is disposed from the roller body portion 60 to the retainer 62. The retainer 62 and the shaft 64 are prevented from rotating and fixed to each other by a fixing member. An end portion of the shaft 64 extending from the retainer 62 is fixed to the frame 10 (FIG. 6), so that the roller body portion 60 rotates about the shaft 64 together with the flange portion 61.

The roller body portion 60 may have a constant outer diameter dimension, or the outer diameter dimension may change within a range not exceeding an outer diameter dimension of the flange portion 61. In the present embodiment, the roller body portion 60 has a large-diameter portion 66 having a relatively large outer diameter dimension and a small-diameter portion 67 having a relatively small outer diameter dimension. In the shown example, the large-diameter portion 66 is formed on a central portion in the axial direction, and the small-diameter portion 67 is formed at both end portions of the large-diameter portion 66. The flange portions 61 are located between both end portions of the large-diameter portion 66 and the small-diameter portion 67, respectively. An outer peripheral surface 67a of the small-diameter portion 67 is a contact portion with which the link 16 of the crawler belt 14 comes into contact at an upper portion, and an outer peripheral surface 66a of the large-diameter portion 66 is a facing portion that is separated from and faces the crawler belt 14.

In addition, an insertion hole 70 into which the shaft 64 is inserted is formed inside the roller body portion 60, and a lubricant holding portion 71 is formed to communicate with the insertion hole 70. The insertion hole 70 has a constant or substantially constant diameter dimension between both end portions of the roller body portion 60. The lubricant holding portion 71 is a portion that holds a lubricant in a fluid state such as lubricating oil, and is formed to be enlarged with respect to the insertion hole 70. In the present embodiment, the lubricant holding portion 71 is located at a central portion of the roller body portion 60 in a longitudinal direction and is located inside the large-diameter portion 66.

The roller body portion 60 may be formed of a plurality of members or may be integrally formed according to the size of the carrier roller 21. In the present embodiment, the roller body portion 60 is integrally formed by two rim members 73 having a cylindrical shape butting against each other in the axial direction and being welded to each other. Therefore, a welding portion 74 for welding the rim members 73 to each other is formed at the central portion of the roller body portion 60 in the axial direction. The welding portion 74 is located on end surfaces of the rim members 73 facing each other and continues over an entire circumference of the roller body portion 60.

The flange portion 61 restricts a left-right position of the crawler belt 14 such that the crawler belt 14 does not fall off from the carrier roller 21. The flange portions 61 may be a pair or two or more pairs depending on the size of the carrier roller 21. However, in the present embodiment, a pair of flange portions 61 set at positions closer to the central portion than both end portions of the roller body portion 60, that is, in the present embodiment, set at positions at which the large-diameter portion 66 and each of the small-diameter portions 67 are connected are shown. The flange portion 61 protrudes in a radial direction from the outer peripheral surface of the roller body portion 60 over the entire circumference of the roller body portion 60.

Further, recessed portions 76 are formed at both end portions of the roller body portion 60. The recessed portions 76 are formed to communicate with the insertion hole 70. A bush 77 is disposed from the recessed portion 76 to the insertion hole 70, and a seal assembly 78 is disposed inside the recessed portion 76 on one end portion side.

The bush 77 has a cylindrical shape into which the shaft 64 is inserted, is press-fitted into each of both end portions of the insertion hole 70, and has an outer peripheral surface in close contact with an inner surface the insertion hole 70 from the recessed portion 76 to the lubricant holding portion 71. An inner diameter dimension of the bush 77 is slightly larger than an outer diameter dimension of the shaft 64, and the bush 77 is rotatable with respect to the shaft 64 together with the carrier roller 21.

The seal assembly 78 prevents the lubricant from leaking from the lubricant holding portion 71 and prevents mud, dirt, and the like from entering the lubricant holding portion 71 from the outside into a rotary part. The seal assembly 78 is configured such that a roller-side seal portion 80 as a first seal portion located on the roller body portion 60 side and a retainer-side seal portion 81 as a second seal portion located on the retainer 62 side are adjacent to each other in the axial direction.

The roller-side seal portion 80 has an annular seal ring 83 and a seal member 84 that is held on an outer periphery of the seal ring 83 and is in pressure contact with an inner surface of the recessed portion 76 with respect to the roller body portion 60. Similarly, the retainer-side seal portion 81 has an annular seal ring 85 and a seal member 86 that is held on an outer periphery of the seal ring 85 and is in pressure contact with the retainer 62. The seal rings 83 and 85 are located adjacent to each other in the axial direction of the carrier roller 21.

The retainer 62 is press-fitted to an end portion of the shaft 64 at a position where the lubricant is prevented from passing between the seal rings 83 and 85 and an inner side surface of the recessed portion 76 and between the seal members 84 and 86 and the inner side surface of the recessed portion 76. The retainer 62 is formed in a cylindrical shape and has a frustum (truncated cone) shape in which an outer peripheral surface is reduced in diameter toward one end portion side. One end portion of the retainer 62 is inserted into the recessed portion 76, and the other end portion side protrudes from the roller body portion 60. An axial gap is formed between one end portion of the retainer 62 and the bush 77 in order to supply the lubricant from the lubricant holding portion 71 to the seal assembly 78.

In addition, the recessed portion 76 on the other end portion side of the roller body portion 60 is covered with the cover 63. The cover 63 has a cover body portion 88 having a cylindrical shape and a cover flange portion 89 that protrudes from an outer peripheral surface of the cover body portion 88. The cover body portion 88 is press-fitted into the recessed portion 76, and an outer peripheral surface thereof is in close contact with the inner side surface of the recessed portion 76. The flange portion 61 abuts on an end portion of the roller body portion 60 outside the recessed portion 76.

Further, a circular plate-shaped retainer plate 91 is fixed to the other end portion of the shaft 64 by, for example, a bolt 92 and the like.

In addition, in the present embodiment, a groove portion 95 for heat dissipation is formed on the crawler roller 13. The groove portion 95 is formed on at least any one of the track rollers 20 and/or in at least any one of the carrier rollers 21. The groove portion 95 is formed in, for example, a substantially V-shape in cross section. That is, in the groove portion 95, side surfaces that rise from a bottom portion are farther away from each other as they are farther away from the bottom portion, and are expanded toward an opening side with respect to the bottom portion.

FIGS. 1 to 4 show examples of the groove portion 95 formed on the track roller 20. The groove portion 95 is formed on at least any of the flange portions 26 and the outer peripheral surface of the roller body portion 25 excluding the flange portions 26.

In a first example shown in FIG. 1(a) and 1(b), the groove portion 95 is formed in an annular shape on the outer peripheral surface of the roller body portion 25, that is, on each of the outer peripheral surface 31a of the small-diameter portion 31 and the outer peripheral surface 32a of the large-diameter portion 32. In this example, a plurality of the groove portions 95 are formed and are independent of each other while being separated from each other in the axial direction. A plurality of the groove portions 95 are formed on the outer peripheral surface 31a of the small-diameter portion 31 and a plurality of the groove portions 95 are formed on the outer peripheral surface 32a of the large-diameter portion 32. The groove portions 95 formed on the outer peripheral surface 31a of the small-diameter portion 31 are formed at positions avoiding the welding portion 38. In this example, a depth of the groove portion 95 formed on the outer peripheral surface 31a of the small-diameter portion 31 is set to be larger than a depth of the groove portion 95 formed on the outer peripheral surface 32a of the large-diameter portion 32. In addition, intervals between the plurality of groove portions 95 formed on the outer peripheral surface 31a of the small-diameter portion 31 are constant or substantially constant. Similarly, intervals between the plurality of groove portions 95 formed on the outer peripheral surface 32a of the large-diameter portion 32 are constant or substantially constant.

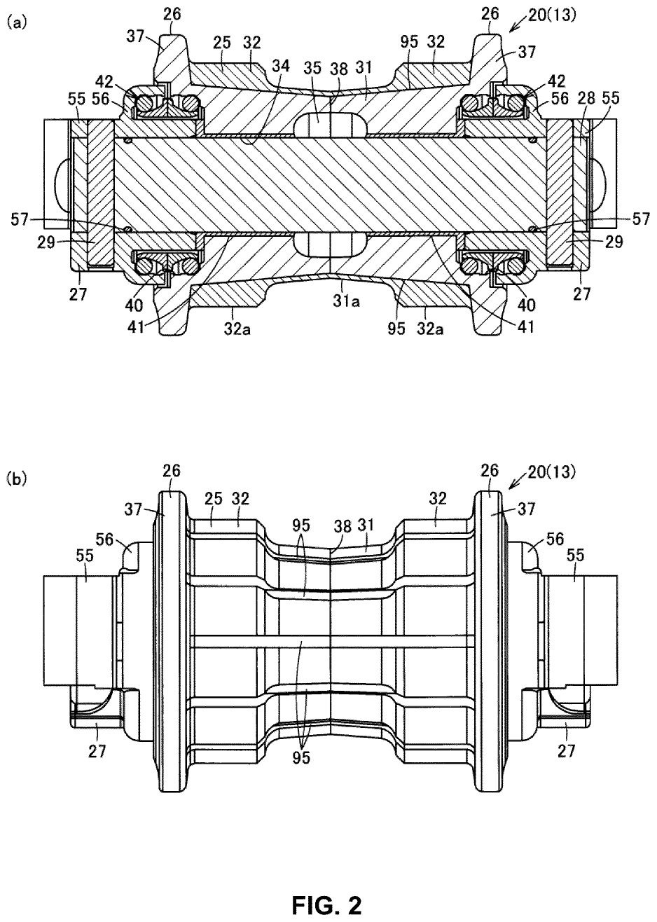

In addition, in a second example shown in FIG. 2(a) and 2(b), a plurality of groove portions 95 are formed on the outer peripheral surface of the roller body portion 25 along the axial direction of the track roller 20 (roller body portion 25). In this example, the groove portion 95 is formed to extend between the flange portions 26 and 26 and to be continuous with the outer peripheral surface 32a of the large-diameter portion 32 and the outer peripheral surface 31a of the small-diameter portion 31. Therefore, in this example, the groove portion 95 is formed across the welding portion 38, and the welding portion 38 is located at a bottom portion of a central portion of each groove portion 95. The groove portions 95 are equally or substantially equally spaced in a circumferential direction. That is, the groove portions 95 are independent of each other while being separated from each other in the circumferential direction. For example, the groove portion 95 is formed such that a depth thereof gradually increases toward the central portion of the roller body portion 25 in the axial direction. In the shown example, the groove portions 95 have a linear shape, but are not limited thereto. For example, the groove portions 95 may have a spiral shape curved in the circumferential direction while maintaining a distance from each other.

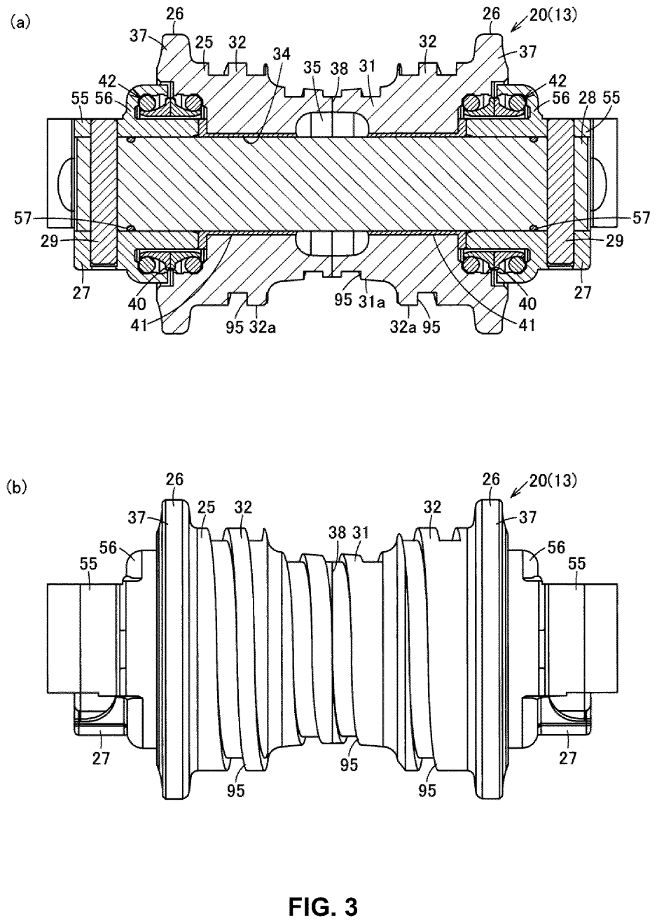

Further, in a third example shown in FIG. 3(a) and 3(b), the groove portions 95 are formed in a spiral shape with respect to the axial direction of the track roller 20 (roller body portion 25). In the shown example, the groove portions 95 are formed in a spiral shape from a position near one flange portion 26 to a position near the other flange portion 26. In the shown example, the groove portions 95 are formed independently on the outer peripheral surface 32a of one large-diameter portion 32, the outer peripheral surface 31a of the small-diameter portion 31, and the outer peripheral surface 32a of the other large-diameter portion 32. Therefore, in this example, the groove portion 95 formed on the outer peripheral surface 31a of the small-diameter portion 31 is formed across the welding portion 38, and the welding portion 38 is located at a bottom portion of a central portion of the groove portion 95.

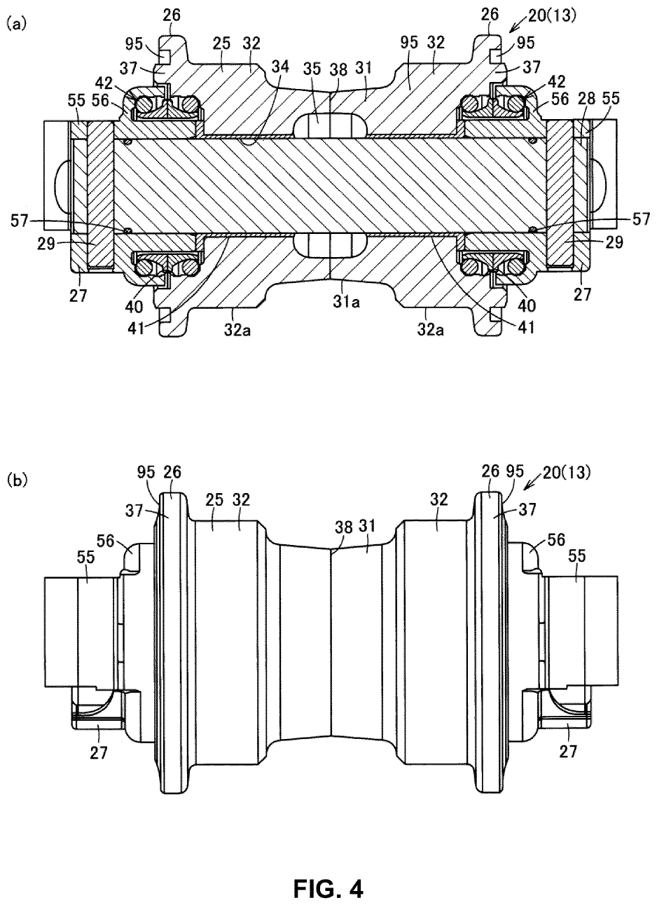

In addition, in a fourth example shown in FIG. 4(a) and 4(b), the groove portion 95 is formed on the flange portion 26. In this example, the groove portion 95 is formed in an annular shape on an end surface on an outer side of the flange portion 26. In the shown example, one groove portion 95 is formed, but is not limited thereto, and a plurality of groove portions 95 may be formed concentrically. In addition, the groove portion 95 may be formed radially in a radial direction, or may be formed in an annular shape and radially.

In addition, the examples of the groove portion 95 shown in FIGS. 1 to 4 may be optionally combined.

In addition, in the above examples, the groove portion 95 is formed to have a constant or substantially constant width dimension, but is not limited thereto, and a portion having a different width dimension may be partially included in the groove portion 95.

Furthermore, FIG. 5(a) and 5(b) show an example of the groove portions 95 formed on the carrier roller 21. The groove portion 95 is formed on at least any of the flange portions 61 and the outer peripheral surface of the roller body portion 60 excluding the flange portions 61.

In the shown example, the groove portions 95 are formed in an annular shape on the outer peripheral surface of the roller body portion 60, that is, on the outer peripheral surface 66a of the large-diameter portion 66 and the outer peripheral surfaces 67a of the small-diameter portions 67, respectively. In this example, a plurality of the groove portions 95 are formed and are independent of each other while being separated from each other in the axial direction. A plurality of the groove portions 95 are formed on the outer peripheral surface 66a of the large-diameter portion 66 and a plurality of the groove portions 95 are formed on each of the outer peripheral surfaces 67a of the small-diameter portions 67. The groove portions 95 formed on the outer peripheral surface 66a of the large-diameter portion 66 are formed at positions avoiding the welding portion 74. In this example, a width dimension of the groove portion 95 formed on the outer peripheral surface 66a of the large-diameter portion 66 is set to be smaller than a width dimension of the groove portion 95 formed on the outer peripheral surface 67a of the small-diameter portion 67, and a depth of the groove portion 95 formed on the outer peripheral surface 66a of the large-diameter portion 66 is set to be larger than a depth of the groove portion 95 formed on the outer peripheral surface 67a of the small-diameter portion 67. In addition, the width dimensions and intervals of the plurality of groove portions 95 formed on the outer peripheral surface 66a of the large-diameter portion 66 are constant or substantially constant. Similarly, the width dimensions and intervals of the plurality of groove portions 95 formed on the outer peripheral surface 67a of the small-diameter portion 67 are constant or substantially constant.

In the carrier roller 21 as well, similarly to the examples of the track roller 20 shown in FIGS. 2 to 4, the groove portion 95 may be formed on the outer peripheral surface of the roller body portion 60 along the axial direction and/or in a spiral shape, may be formed on an end surface of the flange portion 61, or may be formed by any combination thereof.

The groove portion 95 is formed when the track roller 20 and/or the carrier roller 21 is manufactured. For example, as in the present embodiment, in a case where the welding portion 38 or 74 is provided, the groove portion 95 may be formed by cutting or the like after welding of the welding portions 38 and 74, and in a case where the welding portion 38 or 74 is not provided, the groove portion may be formed during casting, rolling, or the like.

As described above, in a case where the track roller 20 has the welding portion 38 and in a case where the carrier roller 21 has the welding portion 74, a groove portion may be inevitably formed along the welding portions 38 and 74 during manufacturing. It is assumed that the groove portion 95 of the present embodiment does not include a groove portion that is inevitably formed along the welding portion 38 or 74 due to such welding.

As described above, by forming the groove portion 95 for heat dissipation in which at least a part of the bottom portion does not have the welding portion in at least any of the flange portions 26 or 61 and the outer peripheral surface of the roller body portion 25 or 60 excluding the flange portions 26 or 61, a surface area of the crawler roller 13 (the track roller 20 and the carrier roller 21) is increased by the groove portion 95, and a heat dissipation property can be improved. Therefore, even if the crawler roller 13 generates heat due to friction with the crawler belt 14 during traveling, the heat is dissipated from the surface expanded by the groove portion 95, and the temperature rise can be suppressed. Therefore, it is possible to suppress deterioration of the seal members 51 and 53, the seal members 84 and 86, or the lubricant caused by the high temperature of the crawler roller 13, and it is possible to suppress contamination of the soil due to leakage of the lubricant, the entry of mud or the like, and the seizure due to poor lubrication.

By forming the groove portions 95 on the outer peripheral surface of the roller body portion 25 or 60 in a direction intersecting with the axial direction of the roller body portion 25 or 60, along the axial direction of the roller body portions 25 or 60, or in a spiral shape with respect to the axial direction of the roller body portion 25 or 60, a large number of the groove portions 95 can be easily formed by effectively using the outer peripheral surface of the roller body portion 25 or 60.

In addition, by forming the groove portions 95 formed on the flange portions 26 or 61 concentrically or radially in a radial direction, a large number of the groove portions 95 can be easily formed by effectively using the flange portions 26 or 61.

In addition, by providing the above-described crawler roller 13 (the track roller 20 and/or the carrier roller 21), the crawler 13 can be smoothly rotated. Therefore, the crawler-type traveling device 2 capable of suppressing the friction between the crawler roller 13 and the crawler belt 14 and suppressing the wear or damage of the crawler roller 13 or the crawler belt 14 can be provided, and by adopting the crawler-type traveling device 2, the crawler-type machine 1 having high durability and reliability can be provided.

In the above-described embodiment, examples of an internal structure are described in detail in order to describe the crawler roller 13 (the track roller 20 and/or the carrier roller 21). However, the present invention is not limited to the crawler roller 13 having the internal structure as described above, and can be applied to a crawler roller having any internal structure.

### INDUSTRIAL APPLICABILITY

The present invention can be used in industries that manufacture and sell crawler rollers, crawler-type traveling devices, and crawler-type machines.

### REFERENCE SIGNS LIST

1: crawler-type machine

2: crawler-type traveling device

13: crawler roller

14: crawler belt

25, 60: roller body portion

26, 61: flange portion

95: groove portion

1. A crawler roller that supports and guides a crawler belt, comprising:
a roller body portion having a cylindrical shape;
a pair of flange portions for preventing the crawler belt from falling off, the flange portions protruding from the roller body portion in a radial direction; and
groove portions for heat dissipation in which at least a part of a bottom portion does not have a welding portion, the groove portions being formed on at least any of the flange portions, and an outer peripheral surface of the roller body portion excluding the flange portions.

2. The crawler roller according to claim 1,
wherein the groove portions are formed on the outer peripheral surface of the roller body portion in a direction intersecting with an axial direction of the roller body portion.

3. The crawler roller according to claim 1,
wherein the groove portions are formed on the outer peripheral surface of the roller body portion along an axial direction of the roller body portion.

4. The crawler roller according to claim 1,
wherein the groove portions are formed on the outer peripheral surface of the roller body portion in a spiral shape with respect to an axial direction of the roller body portion.

5. The crawler roller according to claim 1,
wherein the groove portions formed on the flange portions are formed concentrically.

6. The crawler roller according to claim 1,
wherein the groove portions formed on the flange portions are formed radially in a radial direction.

7. A crawler-type traveling device comprising:
a crawler belt; and
the crawler roller according to claim 1 that supports and guides the crawler belt.

8. A crawler-type machine comprising:
the crawler-type traveling device according to claim 7.
